(19) United States
(12) Patent Application Publication
(10) Pub. No.: US 2024/0083752 A1
(43) Pub. Date: Mar. 14, 2024

(54) Methods for Synthesis of Graphene from Asphaltenes

(71) Applicant: Olanrewaju Tanimola, Sugarland, TX (US)

(72) Inventor: Olanrewaju Tanimola, Sugarland, TX (US)

(21) Appl. No.: 17/931,102

(22) Filed: Sep. 9, 2022

(51) Int. Cl. C01B 32/186; C01B 32/196

(52) U.S. Cl. CPC C01B 32/186; C01B 32/196; C01P 2002/76

(57) ABSTRACT

The present invention discloses a method for synthesizing graphene by eliminating one or more functional groups from a 2D carbon allotropes of graphene having a lattice structure selected from an orthorhombic system, a monoclinic system, and a triclinic system. The present invention discloses a method for synthesizing graphene by eliminating one or more functional groups from a network of one or more 2D nanostructures having a lattice structure formed by an asymmetric structural unit (CxHyF) where x=6, or 7, 3<=y<=9 and F is one or more functional groups.

### CROSS-REFERENCE TO RELATED APPLICATIONS

This application claims the benefit of the filing date of and priority to U.S. Provisional Application Ser. No. 62/035,140 entitled “Methods for Synthesis of Graphene Derivatives and Functional Materials from Asphaltenes”, filed Aug. 10, 2015, the entire contents of the said provisional application is hereby incorporated by reference.

### BACKGROUND OF THE INVENTION

### Field of the Invention

The present invention is a method for synthesizing. More specifically, the present invention is a method for synthesizing graphene from asphaltenes.

### Description of the Related Art

The phenomenology of retrofitting graphene into existing architecture is a well-documented practice in a wide range of technological advancement. The prospect of harnessing phenomenal physio-chemical properties of new allotropic forms of pure carbon has raised numerous possibilities in a wide range of technologies. Fundamentally, carbon exhibits a proclivity to exist in different forms, its ability to form sp, sp² and sp³ hybridized bonds has resulted in the synthesis of numerous carbon nanoscale dimensions. Perhaps, sp² bonded with nanoscale dimensions such as; fullerene, carbon nanotubes and graphene have sparked intense research in in a wide range of technology. These unique and interesting carbon nanostructured materials are often regarded as the most important building blocks that could revolutionize nanotechnology. This development has triggered the emergence of numerous production processes broadly categorized into by two techniques: bottom-up (e.g., CVD, epitaxial growth on SiC, arc discharge, chemical synthesis etc.) and top-down (e.g., exfoliation methods). Although these graphene materials have been shown to outperform conventional materials in technologies ranging from energy application to biotechnology. However, limitations such as, structural randomness and lack of stoichiometry have often resulted in contentious remarks and inability to identify key factors responsible for their underlying their performance.

Advancement in graphene technology is hindered by challenges such as product quality, low-cost and scalable process, sustainability, consistency in performance, Variations in modification method and selection of different starting material are responsible for the disparity in properties such as morphology, reactivity, levels of impurities and dispersibility of materials having the same classification i.e. GO/RGO. This randomness and inability to effectively characterize and effectively categorize existing graphene derivatives have often resulted in contentious remarks on the key factors underlying the performance of RGO and GO. To address present graphene limitations, there is a need for a strategy that addresses economical, technical, and environmental challenges. An inexpensive large-scale production technique that will provide control over physiochemical properties like size, number of layers, purity etc. while ensuring environmental safety is vital for the commercialization of this 2D carbon allotropes.

Despite over a decade of investigation and tall claims on graphene capabilities, it has yet to make in-roads into real-life applications. Despite the availability of a plethora of processing techniques for graphene materials, inability to produce a high-quality graphene material in a cost effective and scalable way has continued to prolong its timeline for full commercialization.

To address these limitations, a cost effective and reproducible method of producing a high quality or atomically precise graphene material through the control of chemical and physiochemical properties such as size, number of layers, heteroatom dopants and functional groups needs to be demonstrated.

On the other hand, asphaltene imparts a high viscosity to crude oils and has a negative impact on production. It has high maintenance costs and causes production and transportation of crude oil to come to a halt. Asphaltene precipitation and subsequent deposition in production tubing and topside facilities present significant cost penalties to crude oil production. An estimated average cost of $2 billion dollars is spent annually by US petroleum refinery. The estimated total cost of solving major asphaltene related problems such as; corrosion control in refineries is placed at $3.692 billion annually, 47.9% of this cost is maintenance-related expenses, 38.6% accounts for vessel turnaround expenses and 1.32% is expended on fouling related problems. While they are presently utilized for practical uses such as road construction material, water-proofing and roofing material, and as curing agents/corrosion inhibitors, the potential of asphaltenes has not been fully explored and the isolation/production of asphaltene outpaces its utilization.

To justify asphaltene separation it is imperative to discover new ways of utilizing asphaltenes in a more value-added or unique way.

Moreover, the impact of CO2 on climate change has ignited new development in materials processing. In recent years, tremendous efforts are being committed towards developing synthetic approach that captures and utilize CO2 in a sustainable manner.

There is a need for a climate change mediation approach which could be in the form of CO2 usage.

### SUMMARY OF THE INVENTION

The present invention is a method for synthesizing graphene comprising: contacting an asphaltene composition with CO2 wherein a carboxylated asphaltene derivative is produced; contacting the carboxylated asphaltene derivative with one or more modifying agents or reducing agents wherein a graphene composition is produced; purifying the graphene composition to isolate a pure graphene material.

The present invention is a method for synthesizing pure and precise graphene by eliminating one or more functional groups from an atomically precise comprising a network of one or more 2D nanostructures having a lattice structure selected from an orthorhombic, a monoclinic or a triclinic system formed by an asymmetric structural unit (CxHyF)n where x=6, or 7, n=>1, 3<=y<=9, F is one or more functional groups

The present invention is a method for synthesizing graphene by eliminating one or more functional groups from a graphene derivative. The graphene derivative comprises a network of one or more 2D nanostructures having a lattice structure selected from an asymmetric unit comprising one or more arenes, an orthorhombic system, a monoclinic system, and a triclinic system.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of the specification embodiments presented herein.

Figure I illustrates a packing system of one of the graphene derivatives (C6H4N2O4)n

FIG. 2 illustrates a supramolecular structure of the synthesized graphene derivative having asymmetric unit (C6H4N2O4) n when viewed down the section

FIG. 3 shows the SEM images of synthesized graphene material of present invention.

FIG. 4 shows the EDS analysis of synthesized graphene material of present invention.

FIG. 5 shows Process flow chart of present invention

FIG. 6 shows Raman Spectrum of synthesized graphene material of present invention

FIG. 7 shows XRD pattern of synthesized graphene material of present invention

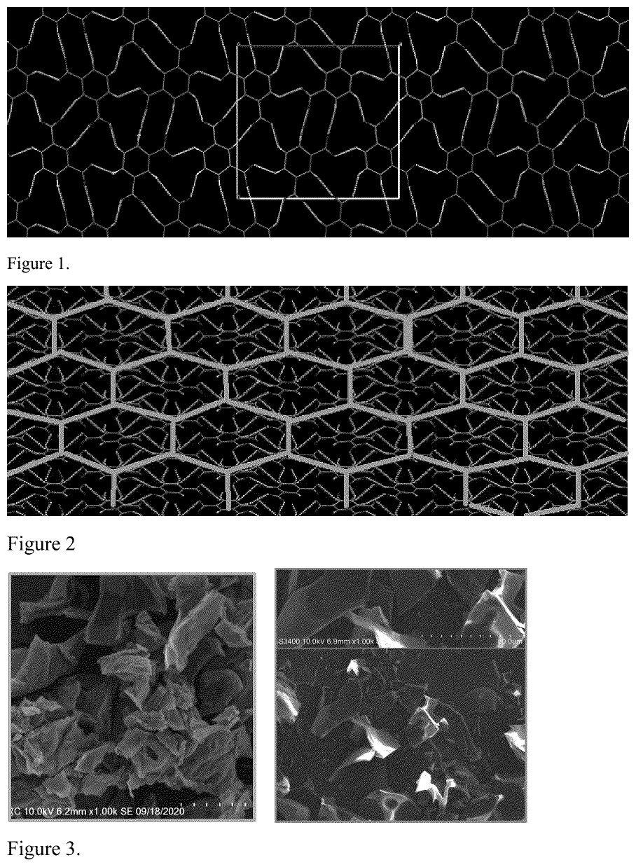

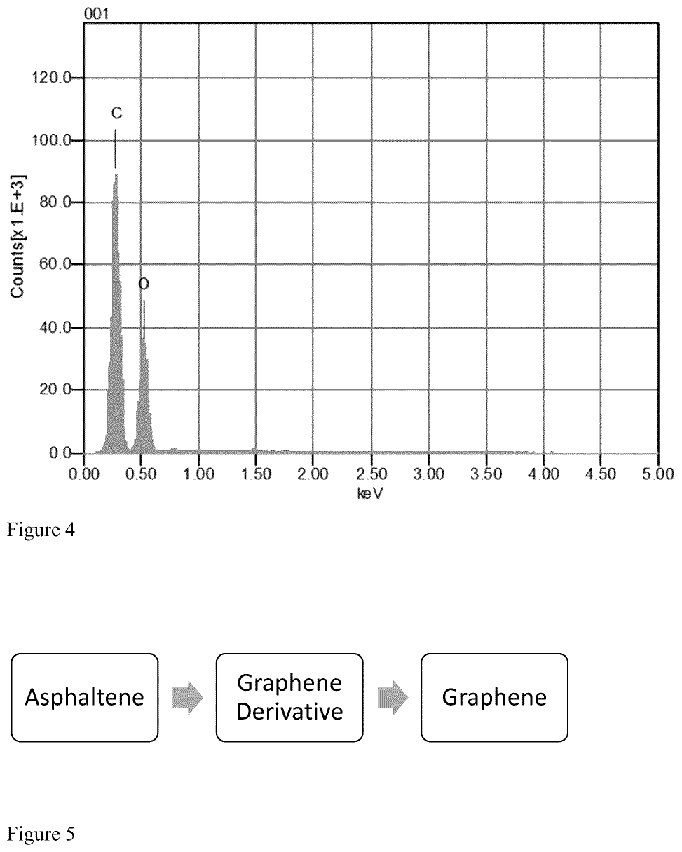

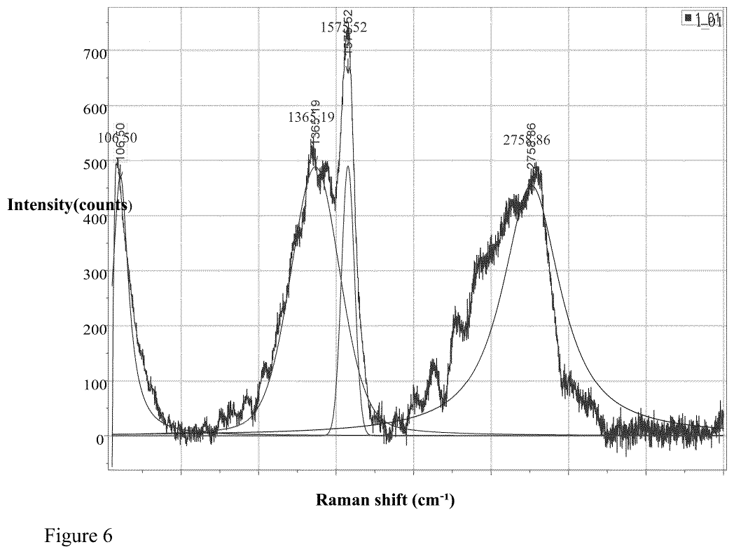

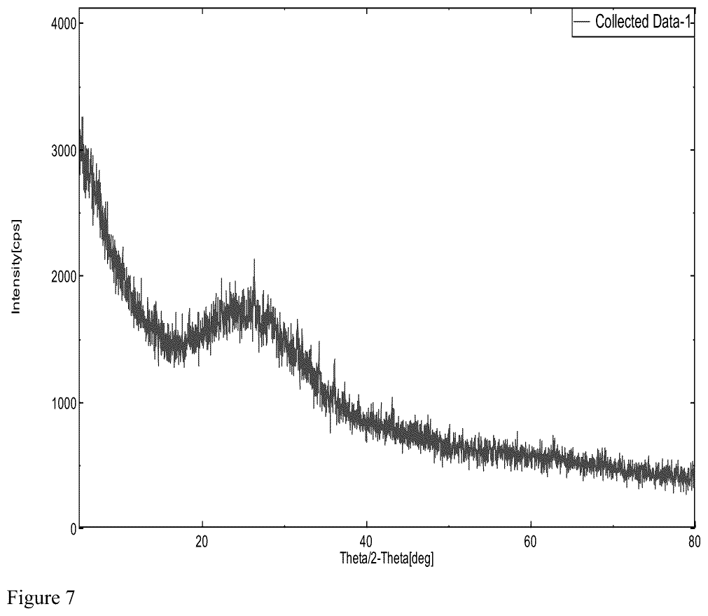

### DETAILED DESCRIPTION OF THE INVENTION

Graphene exhibits a unique 2-D structure and exceptional electrical, physical, and chemical properties. It is a sheet of carbon having a one-atom thickness. This two-dimensional nanomaterial is composed of sp2-bonded carbon atoms. Its physical configuration imparts various properties like extreme electrical conductivity at room temperature. Graphene also exhibits a number of extraordinary electronic, optical, thermal and mechanical properties. Graphene is a strong yet bendable and stretchable material. It is transparent since it only absorbs a few percent of visible light that hits it. Graphene is a zero-gap semiconductor or zero-overlap semimetals since unlike semiconductors it does not have a threshold for electronic excitations. Graphene has a negative thermal expansion coefficient, a high optical phonon frequency, and high thermal conductivity. Bio-sensing systems are made possible due to the quantum confinement and edge effect of the graphene structure. Graphene undoubtedly is the most recognized 2D material; it is widely regarded as a revolutionary material that could disrupt a wide range of technologies. More than a decade of graphene studies has resulted in the emergence of numerous structural morphologies and processing techniques.

Graphene or graphene product described in present invention included but not limited to single layer graphene (SLG), bi-layer graphene (BLG), few layer graphene (FLG), multi-layer graphene, graphene nanoribbon, 3D Graphene, graphene fiber, graphene quantum dots, zig-zag graphene, armchair graphene, and nanographene (NGR).

Graphene production techniques broadly classified into two main categories, i.e. bottom-up (e.g., CVD, epitaxial growth on SiC, arc discharge, chemical synthesis etc.) and top down (e.g., exfoliation methods) processes.

However, despite over a decade of investigation and tall claims on graphene capabilities, it has yet to make in-roads into real-life applications. Despite the availability of a plethora of processing techniques for graphene materials, the inability to produce a high-quality graphene material in a cost effective and scalable way has continued to prolong its timeline for full commercialization.

To address these limitations, a cost effective and reproducible method of producing a high quality or atomically precise graphene material through the control of chemical and physiochemical properties such as size, number of layers, heteroatom dopants and functional groups needs to be demonstrated.

There is a need for additional methods for handling asphaltenes and methods for modifying them to produce useful compositions.

Asphaltenes may be processed to obtain (i) metallized asphaltenes (e.g., by hot mixing of asphaltenes and metals, and drying), (ii) demetallized asphaltenes (e.g., purification with solvents or reaction with strong acids and drying under vacuum), and (iii) fractionated asphaltenes (obtaining different fractions by employing two or more solvents that may be employed at different period of time or mixed at a known proportion).

Metallized asphaltene is the asphaltene that is mixed with metals by known processing methods. When metals are removed from asphaltenes the remaining product is called demetallized asphaltene. Demetallized asphaltenes are obtained via the reaction of asphaltenes with acids, preferably strong acids. Methods employed for the insertion and removal of metals from polymers, small and large molecules may also be applicable to asphaltenes (for example see U.S. publication 20130220421, which is incorporated herein by reference).

Also, asphaltenes can be described as a mixed asphaltene. Mixed asphaltene describes a mixture of asphaltene with other materials. It includes the treatment of asphaltenes with materials that include polymers, small molecules, large molecules, ceramics, composites, halogens, non-metals, semiconductors, and mixtures thereof.

Asphaltenes may be modified to obtain variation in the structure. Modification may include thermal, chemical and mechanical modifications.

### A Isolation/Separation of Asphaltenes

There are several methods for characterizing crude oil components, as well as isolating and identifying asphaltenes. In certain methods the isolation of asphaltenes is initiated by precipitation of asphaltenes followed by the purification of the asphaltene precipitate. In a further aspect the asphaltenes can be solubilized prior to or after precipitation.

One example of isolating asphaltene from crude oil comprises dissolving crude oil heptane, stirring the heptane/crude oil mixture for about 48 hours at room temperature. Filtering the mixture through filter paper and rinsing the filtrate using toluene. The filtered solution is dried and a crude asphaltene composition collected from the filter.

The crude asphaltene preparation can then be further purified. Crude asphaltene is dissolved in toluene and stirred for about 5 hours. The stirred solution is filtered, using for example filter paper no. 40. Purified asphaltene passes through the filter paper while impurities remain on the filter. The filtered asphaltene solution is dried at room temperature. The result is purified asphaltene that is typically a black shiny product. This product can then be further derivatized using the methods described herein.

Depending on the asphaltene starting material, it should be appreciated that the structure of asphaltene extracted from contemplated methods may vary considerably.

### B. Methods for Making Graphene

It is an object of the present invention to provide a method for synthesizing graphene from asphaltenes that includes an asymmetric unit provides precise details of the atoms and molecules that make up the building block of layered nanostructure. In addition, the present invention discloses a method of controlling number of layers or isolating individual atomic planes from a bulk composition like asphaltene.

It is an object of the present invention to provide a method for synthesizing graphene from asphaltenes that discloses a reproducible and scalable production process of transforming asphaltene into graphene with control over number of layers, size, and morphology. Specifically, nanocarbon graphene describe in present invention are produced via the de-modification or reduction of an asphaltene derivative.

It is an object of the present invention to disclose a method of producing graphene comprising: providing a dispersed asphaltene composition comprising an asphaltene material, and one or more surfactants; refluxing the dispersed asphaltene composition to form a refluxed asphaltene derivative; performing chemical exfoliation on the refluxed asphaltene derivative to extract a graphene material.

It is an object of the present invention to disclose a method of producing graphene comprising: providing a dispersed asphaltene composition comprising an asphaltene material, and one or more dispersants or one or more additives; refluxing the dispersed asphaltene composition to form a refluxed asphaltene derivative; performing chemical exfoliation on the refluxed asphaltene derivative to extract a graphene material.

Chemical exfoliation includes reduction, dehydrogenation, thermal treatments, or a combination thereof. The surfactant comprises a sulfonic acid composition or alkyl sulfonic acid oxonium salt.

The dispersant comprises a selection from p-alkylphenols, p-alkylbenzenesulfonic acid, or alkyl sulfonic acid.

Prior art described surfactants; WO 2013/165869 is incorporated herein for all purposes of the processing.

The one or more additives may comprise an oxidant, a solvent, a surfactant or a dispersant. In one embodiment, the selected temperature ranges from about 25° C. to about 120° C. The oxidant may be selected from any of mixed acids, hydrogen peroxide, methanol, ammonia, hydrochloric acid, taurine, nitric acids, sulfuric acids, water, alkyl toluene sulfonic acid and any combination thereof. The solvent may comprise any of: ammonia, methanol, aromatic solvents, water, tetrahydrofuran, diethyl ether, carbon tetrachloride, hydrogen peroxide, sulfate, alkyl phenol, toluene, benzene, xylene and any combination thereof. The surfactant may comprise alkyl sulfonic acid oxonium salt. In one embodiment, the dispersant comprises p-alkylphenols, p-alkylbenzenesulfonic acid, or alkyl sulfonic acid. The method may further comprise a step of separating the refluxed solution to produce carbon powder and continuous phase. The separation may comprise filtration, centrifugation, dialysis, solvent extraction, recrystallization, adding solvent and any combination thereof. The method may further comprise adding modifying agent to the refluxed solution to form a modified solution. The modifying agent may comprise any of sodium hydroxide, sodium borohydride, methanol, dioxane, hydrochloric acid, sodium tetrahydrofuran, carbon tetrachloride, copper chloride, phosphoric acid, water, methanol, hydrochloric acid, sodium nitrite, sodium sulfide, copper bromide and a combination thereof. The method can further comprise separating modified solution into carbon powder and continuous phase using any of filtration, centrifugation, dialysis, washing, recrystallization, solvent extraction, addition of solvent, and a combination thereof.

It is an object of the present invention to provide a method for synthesizing graphene from asphaltene via a surface growth technique including the depositing a graphene derivative on a substrate. The graphene derivative has a orthorhombic, or a monoclinic lattice system.

It is an object of the present invention to provide a method for synthesizing graphene from asphaltene via a solution phase growth technique.

It is an object of the present invention to provide a method for synthesizing graphene from a graphene derivative via a vapor deposition technique including—chemical vapor deposition (CVD) or large area CVD. The graphene derivative comprises a network of one or more 2D nanostructures having a lattice structure formed by an asymmetric structural unit (CxHyF) where x=6, or 7, 3<=y<=9, where F is one on more selection from oxygen group, nitro-group, sulfur group, a carboxylic group, or a combination thereof.

It is an object of the present invention to provide a method for synthesizing graphene by contacting a reducing agent with an asphaltene derivative. The asphaltene derivative is selected from the group consisting of a refluxed asphaltene derivative, a modified asphaltene derivative, or a controlled asphaltene derivative.

It is an object of the present invention to provide a method for synthesizing graphene, the method comprising: providing a composition comprising a network of one or more 2D carbon nanostructures. having a lattice structure formed by an asymmetric structural unit (CxHyF) where x=6, or 7, 3<=y<=9, where F is one or more functional group comprising a selection from one or more oxygen groups, one or more nitro-groups, one or more sulfur groups, one or more carboxylic groups, one or more alkyl groups, or a combination thereof; processing the said composition by performing one or more processing steps selected from contacting with one or more reducing agents, contacting with heat, contacting with thermal energy, contacting with electromagnetic wave, contacting with one or more dehydrating agents, contacting with one or more dehydrogenating agents, heating, pressurizing, freezing, or any combinations thereof.

It is an object of the present invention to provide a method for synthesizing graphene by eliminating one or more functional groups from a graphene derivative. The graphene derivative comprises a network of one or more 2D nanostructures having a lattice structure selected from an orthorhombic system, a monoclinic system, and a triclinic system

It is an object of the present invention to disclose a method of producing a graphene material, the method comprising (i) contacting an asphaltene composition with one or more additives, or providing a composition comprising a network of one or more 2D nanostructures having a lattice structure comprising a selection from an asymmetric unit (CxHy)n, where x=6, y=6, an orthorhombic system, a monoclinic system, or a triclinic system. It is an object of the present invention to disclose a method of producing a graphene material, the method comprising: (i) providing a composition comprising a network of one or more 2D carbon nanostructures having a lattice structure formed by an asymmetric structural unit (CxHyF) where x=6, or 7, 3<=y<=9, where F is one or more functional groups comprising a selection from one or more oxygen groups, one or more nitro-groups, one or more sulfur groups, one or more carboxylic groups, one or more alkyl groups, or a combination thereof. (ii) Performing one or more processing steps selected from contacting with one or more reducing agents, contacting with heat, contacting with thermal energy, contacting with electromagnetic wave, contacting with one or more dehydrating agents, contacting with one or more dehydrogenating agents, contacting with one or more spinning object, stretching, carbonizing, sizing, surface treatment, or any combinations thereof. (iii) Performing one or more purification steps to produce an aromatic product, a graphene product, and a hydrogen product.

It is an object of the present invention to provide a method for synthesizing graphene involving an asphaltene derivative, the method includes refluxing an dispersion for a period of time to form a refluxed asphaltene derivative, contacting the refluxed asphaltene derivative with a modifying agent or a basic solution to form a modified asphaltene derivative, contacting the modified asphaltene derivative with a controlling agent or an acidic solution to form a quenched asphaltene derivative, Performing one or more steps of contacting the refluxed asphaltene derivative, or the modified asphaltene derivative or the quenched asphaltene derivative with a reducing agent to produce a reduced asphaltene derivative. Performing one or more separation techniques to produce an aromatic product, a graphene product, and hydrogen.

It is an object of present invention to provide method for synthesis of graphene including the use of one or more additives selected from but not limited to nitric acid, sulfuric acid, aromatic solvent, polar solvent, methanol, water, peroxide, formic acid, benzene, toluene, naphthalene, nitrobenzene sulfonic acid, linear alkyl sulfonic, polytetrafluoroethylene, sodium nitro sulfonic acid, sodium dodecyl sulfate, cetyltrimethylammoniumbromide, phospholipid, lignin, sulfuric acids, ammonia, taurine, tetrahydrofuran, sulfur trioxide, carboxylic acid, acetic acid, carboxylic acids, sulfonic acids and derivatives, carbonic acids, nitro-sulfonic acids, oleic acid, methyl cellulose, diethylene glycol, polyoxyethylene sorbitan monolaurate, hydrogen peroxide, oxalic acid, perchloric acid, iron bromide, iron chloride, phosphoric acid, hydrofluoric acid, chlorosulfonic acid, trifluoromethanesulfonic acid, nickel, iron, vanadium, permanganate, oleum, chloride, chlorite, nitrite, potassium permanganate, methanol, acetone, water, propanol, isopropanol, dimethyl sulfoxide, polyethylene glycol (PEG), polymer copolymer (PEtOz-Pcl), alkyl phenol, water, Dodecyl benzenesulphonic acid, methanol, tetrachloromethane, taurine, methionine, trichloromethane, tetrahydrofuran, N-(3-dimethylaminopropyl), N′ ethyl-carbodiimide hydrochloride, N′ hydroxyl succinimide, poly-lysines (PLs), sodium dodecyl benzenesulfonate, platinum, sodium oleate, cysteine, homocysteine, carbon-di-oxide, or any mixtures thereof.

It is an object of present invention to provide method for synthesis of graphene including the use of one or more modifying agents to the tune the surface or interphase of the refluxed asphaltene derivative. A modifying agent may be introduced to alter the edges of the asphaltene emulsion. This may result in structural morphological changes. In certain aspects a modifying agent performs several operations that include without limitation addition of functional group(s), elimination of the functional group(s), and substitution of functional group(s).

The modifying agent comprises without limitation metal catalyst, basic solution, a reducing agent, a salt solution, metal oxides, sulfides, hydrides and any combination thereof. The modifying agent is selected from any of sodium chloride, sodium hydroxide, ammonium hydroxide, hydrochloric acid, tetrahydrofuran, amino triazole, dimethylformamide, dimethylsulfoxide, phosphines, phosphites, sulfites, sulfides, hydrosulfites, borohydrides, boranes, hydroxylamine, lithium alhydride, sodium nitrite, hydrochloric acid, copper bromide, copper cyanide, potassium iodide, borohydrides, hydrochloric acid, cyanoborohydrides, aluminum hydrides, hydroquininone, hydrogen dimethylhydrazine, N,N-dimethylhydroxylamine, methylamine, dioxane, amino acids, dimethylamine, trimethylamine taurine, methionine, potassium hydroxide, tin, methanol, alkali sulfide, distilled water, or any mixtures thereof.

It is an object of present invention to provide method for synthesis of graphene including the use of one or more controlling agents for pH control. The selection of a controlling agent is dependent on the pH of the solution. Controlling agent is selected from any of hydrochloric acid, sodium bicarbonate, methanol, dimethyl sulfoxide, sodium hydroxide, potassium hydroxide, tetrahydrofuran, dimethylformamide, alkali sulfide, dimethylsulfoxide, phosphines, phosphites, sulfites, sulfides, dioxane, hydrosulfites, borohydrides, boranes, distilled water, sodium bicarbonate or any mixtures thereof.

In certain aspects the intercalating solvent (surfactant) is an oxidative acid or a mixture of oxidative acids. An oxidative acid can be sulfuric acid, perchloric acid, nitric acid, or mixtures thereof. An acid component can be present at final concentration of 0.0001, 0.0005, 0.001, 0.005, 0.01, 0.05, 0.1, 0.2, 0.3, 0.4, 0.5, 0.6 M to 0.5, 0.6, 0.7, 0.8, 0.9, I M during reflux. Thermal treatment or refluxing process steps at 25, 30, 35, 40, 45, 50, 55, 60, 65, 70, 75, 80, 85, 90, 95, 100° C. or greater, including all values and ranges there between. The pH of the solution, which during reflux is less than 2 can be controlled by neutralizing the mixture with a base, such as diluted NaOH, KOH, or the like (0.0001 M to IM). Quenching can be accomplished by addition of an acidic solution (e.g., HCl) (0.0001 M to IM). Varying the parameters results in variation of the attribute of the resulting product (e.g., structural morphology, lattice parameter, degree of orderliness etc.). Therefore all variables (e.g., solvents, temperature range, concentration, volume, ratio, time etc.) can be varied to some degree to alter the characteristics of the products.

It is the object of the present invention to disclose a method comprising (i) providing a starting material or a carbon composition comprising a network of one or more 2D carbon nanostructures having a lattice structure selected from the group consisting of an orthorhombic system, a monoclinic system, and a triclinic system, wherein the lattice structure is an asymmetric structural unit (ASU)n wherein n is greater than zero and the ASU is represented by a formula of (CxHyF) wherein x>=6, y>=1, and F is one or more functional groups comprising a selection from one or more oxygen groups, one or more nitro-groups, one or more sulfur groups, one or more carboxylic groups, one or more alkyl groups, or a combination thereof. (ii) contacting the carbon composition with one or more modifying agents or one or more reducing agents to form a reduced carbon composition comprising a network of one or more 2D carbon nanostructures having a hexagonal lattice structure and an asymmetric structural unit (ASU)n wherein n is greater than zero and the ASU is represented by a formula of (CxHy) wherein x>=6, y>=3, or (CxHy) (iii) refluxing the carbon composition or the reduced carbon composition to form a refluxed product comprising a graphene material (iv) performing one or more separation techniques to separate a selection from the carbon composition, the reduced carbon composition or the fluxed product to produce a graphene material (v) performing one or more separation techniques to separate a selection from the carbon composition, the reduced carbon composition or the fluxed product to produce a graphene product, and one or more byproducts comprising a selection from an organic product, a hydrogen product, and a fuel product. suitable separation technique. Examples of the separation techniques are chromatography, liquid-liquid extraction, bilayer membrane, distillation, and other separation techniques. The invention envisions the adaption of several techniques for the separation.

The present invention relates to a method comprising: (i) providing a carbon composition comprising a network of one or more 2D nanostructures having a lattice structure, wherein the lattice structure is an asymmetric structural unit (ASU)n wherein n is greater than zero and the ASU is represented by a formula of (CxHyF) wherein x>=6, y>=1, and F is one or more functional groups comprising one or more alkyl group. (ii) performing one or more process steps selected from the group consisting of contacting the carbon composition with one or more hydro alkylation reagents, contacting with one or more dealkylation reagents, contacting with thermal energy, contacting with steam, contacting with one or more dehydrogenating agents, or a combination thereof. (iii) Performing one or more separation techniques to produce a graphene product and one or more byproducts selected from an organic product, a hydrogen product, and a fuel product.

In one embodiment this method may be regarded as a functionalization, oxidation, and reduction process. It involves physisorption and chemisorption at asphaltene-solvent interface, which facilitates conjugation of a fragment of asphaltenes with an active component of the solvent. It facilitates an affinity to asphaltenes which may result in functional groups being absorbed either on the surface of the asphaltene aggregation or become bonded with the polar group of asphaltene molecules, in certain aspects both are likely to occur. In this method, the interaction between asphaltenes and organic salts promotes strong donors of the hydrogen bonding and may also instill stability on asphaltenes structure.

The introduction of solvents in this method promotes chemisorption and physisorption of molecules of asphaltenes and an active functional group of the solvents. The type of functional group present in the final product is dependent on the choice of solvent.

The graphene material of present invention is formed by contacting an asphaltene derivative or a starting material with one reducing agents or reductants. The starting material is a carbon composition comprising a network of one or more 2D nanostructures having a lattice structure, wherein the lattice structure is an asymmetric structural unit (ASU)n wherein n is greater than zero and the ASU is represented by a formula of (CxHyF) wherein x>=6, y>=1, and F is one or more functional groups comprising one or more alkyl group. (ii) performing one or more process steps selected from the group consisting of contacting the carbon composition with one or more hydro alkylation reagents, contacting with one or more dealkylation reagents, contacting with one or more catalysts, contacting with thermal energy, contacting with steam, contacting with one or more dehydrogenating agents, heating, pressurizing, freezing, or a combination thereof. (iii) Performing one or more separation techniques to produce a graphene product, and one or more byproducts selected from an organic product, an aromatic product, and a hydrogen product.

The graphene material of present invention is having a lattice structure selected from a hexagonal system, an orthorhombic system, a monoclinic system, and a triclinic system.

The asphaltene derivative of present invention includes a selection from refluxed asphaltene derivative, modified asphaltene derivative, neutralized asphaltene derivative, controlled asphaltene derivative, quenched asphaltene derivative, and functionalized asphaltene derivative.

The starting material of the present invention of present invention comprises a network of one or more 2D carbon nanostructures having a cl-spacing or interlayer distance less than or equal to 1.367 nm, wherein the network comprises a lattice structure selected from the group consisting of an orthorhombic system, a monoclinic system, and a triclinic system, wherein the lattice structure is an asymmetric structural unit (ASU)n wherein n is greater than zero and the ASU is represented by a formula of (CxHyF) wherein x=6 or 7, 3<=y<=6, and F is one or more functional groups.

The one or more functional groups is a selection from an electron donor, an electron donor, or a combination thereof.

The one or more functional groups is selected from the group consisting of one or more nitrogen groups, one or more sulfur groups, one or more hydroxyl groups, one or more OR groups, one or more NHOR groups, one or more halogen groups, one or more halide groups, one or more NR2 groups, one or more S03H groups, one or more sulfide groups, one or more azo groups, one or more sulfonate groups, one or more CN groups, one or more CH3 groups, one or more N204 groups, one or more 03SH30 groups, one or more S02 groups, one or more N02 groups, one or more NR3 groups, one or more amide groups, one or more carbonyl groups, one or more oxygen groups, one or more ketone groups, one or more ester groups, one or more carboxyl groups, one or more alkyl groups, one or more acyl groups, one or more carboxylate groups, and combinations thereof.

The reducing agent comprises without limitation a selection from hydrogen sulphide, sodium borohydride, hydrazine, a de-functionalizing agent, a decarboxylating agent, desulfonating agent, a denitrating agent, a modifying agent, an alkaline solution, sodium citrate, amino acids, sugars, ascorbic acid, thermal energy, a metal, zinc, magnesium, primary amine, secondary amine, tertiary amine, copper, sodalime, electromagnetism, polyphenols, tea, microorganisms, or a mixture thereof.

The modifying agent comprises without limitation metal catalyst, basic solution, a salt solution, metal oxides, sulfides, hydrides and any combination thereof.

The modifying agent is selected from the group consisting of sodium chloride, sodium hydroxide, ammonium hydroxide, hydrochloric acid, tetrahydrofuran, amino triazole, dimethylformamide, dimethylsulfoxide, phosphines, phosphites, sulfites, sulfides, hydrosulfites, borohydrides, boranes, hydroxylamine, lithium alhydride, sodium nitrite, hydrochloric acid, copper bromide, copper cyanide, potassium iodide, borohydrides, hydrochloric acid, cyanoborohydrides, aluminum hydrides, hydroquininone, hydrogen dimethylhydrazine, N,N-dimethylhydroxylamine, sulfurous acid, methylamine, dioxane, amino acids, dimethylamine, trimethylamine taurine, methionine, potassium hydroxide, tin, methanol, alkali sulfide, distilled water, or mixtures thereof.

It is the object of the present invention to disclose a method comprising (i) providing a starting material or a carbon composition comprising a network of one or more 2D carbon nanostructures having a lattice structure selected from the group consisting of an orthorhombic system, a monoclinic system, and a triclinic system, wherein the lattice structure is an asymmetric structural unit (ASU)n wherein n is greater than zero and the ASU is represented by a formula of (CxHyF) wherein x>=6, y>=1, and F is one or more functional groups comprising a selection from one or more oxygen groups, one or more nitro-groups, one or more sulfur groups, one or more carboxylic groups, one or more alkyl groups, or a combination thereof. (ii) contacting the carbon composition with one or more modifying agents or one or more reducing agents to form a reduced carbon composition comprising a network of one or more 2D carbon nanostructures having a hexagonal lattice structure and an asymmetric structural unit (ASU)n wherein n is greater than zero and the ASU is represented by a formula of (CxHy) wherein x>=6, y>=3, or (CxHy) (iii) refluxing the carbon composition or the reduced carbon composition to form a refluxed product comprising a graphene material (iv) performing one or more separation techniques to separate a selection from the carbon composition, the reduced carbon composition or the refluxed product to produce a graphene material (v) performing one or more separation techniques to produce a graphene product, and one or more byproducts comprising a selection from an organic product, a hydrogen product, and a fuel product. Examples of the separation techniques are chromatography, liquid-liquid extraction, bilayer membrane, distillation, and other separation techniques. The invention envisions the adaption of several techniques for separation.

The present invention relates to a method comprising: (i) providing a carbon composition comprising a network of one or more 2D nanostructures having a lattice structure, wherein the lattice structure is an asymmetric structural unit (ASU)n wherein n is greater than zero and the ASU is represented by a formula of (CxHyF) wherein x>=6, y>=1, and F is one or more functional groups comprising one or more alkyl groups. (ii) performing one or more process steps selected from the group consisting of contacting the carbon composition with one or more hydro alkylation reagents, contacting with one or more dealkylation reagents, contacting with thermal energy, contacting with steam, contacting with one or more dehydrogenating agents, heating, pressurizing, freezing, or a combination thereof. (iii) Performing one or more separation techniques to produce a graphene product and one or more byproducts selected from an organic product, a hydrogen product, and a fuel product.

It is an object of the present invention to disclose a method of producing a carbon-nanotube material, the method comprising (i) providing a carbon composition comprising a network of one or more nanostructures having a lattice structure comprising a selection from an asymmetric unit (CxHy)n, where x=6, y=6, an orthorhombic system, a monoclinic system, or a triclinic system (ii) providing a nanocomposition comprising a network of one or more 2D carbon nanostructures having a lattice structure formed by an asymmetric structural unit (CxHyF) where x=6, or 7, 3<=y<=9, where F is one or more functional groups comprising a selection from one or more oxygen groups, one or more hydrogen group, one or more nitro-groups, one or more sulfur groups, one or more heteroatoms, one or more carboxylic groups, one or more alkyl groups, or a combination thereof. (iii) Performing one or more process steps of modifying the carbon composition, or the nanocomposition, wherein the modifying comprises performing one or more process steps selected from contacting with one or more reducing agents, contacting with heat, contacting with thermal energy, contacting with electromagnetic wave, contacting with one or more dehydrating agents, contacting with one or more dehydrogenating agents, contacting with one or more spinning object, stretching, carbonizing, sizing, surface treatment, heating, pressurizing, freezing, or any combinations thereof. (iv) Performing one or more purification steps to produce a graphene fiber product, and by one or more byproducts selected from an organic product, a fuel product, and a hydrogen product.

It is an object of the present invention to disclose a method comprising (i) contacting an asphaltene composition with one or more additives to form an asphaltene colloid (ii) providing a carbon composition comprising a network of one or more carbon nanostructures having a lattice structure comprising a selection from an asymmetric unit (CxHy)n, where 6<=x<9 y=6, the lattice structure is selected from hexagonal, orthorhombic or monoclinic (iii) modifying the asphaltene colloid, or the carbon composition by performing one or more processing steps selected from contacting with one or more reducing agents, contacting with heat, contacting with thermal energy, contacting with electromagnetic wave, contacting with one or more dehydrating agents, contacting with one or more dehydrogenating agents, contacting with one or more spinning object, stretching, carbonizing, sizing, surface treatment, heating, pressurizing, freezing, or any combinations thereof. (iv) modifying the asphaltene colloid, or the carbon composition by performing one or more processing steps of contacting with a selection from metal oxide, metal, copper, silica, steam, thermal energy, pressure, or a combination thereof (v) performing one or more purification steps to produce an aromatic product, a graphene fiber product, and a hydrogen product.

It is an object of the present invention to disclose a method comprising providing an asphaltene composition and performing one or more process steps selected from (i) processing the asphaltene composition by contacting with one or more additives to form a metal comprising product, and a demineralized nanocarbon compositions comprising a network of one or more 2D nanostructures having a lattice structure selected from an orthorhombic system, a monoclinic system, and a triclinic system. (ii) contacting the asphaltene composition with one or more additives to form a nanocolloid comprising a network of one or more 2D nanostructures having a lattice structure selected from an orthorhombic system, a monoclinic system, and a triclinic system. (iii) modifying the demetallized nanocarbon composition, or the nanocolloid to form a modified nanocolloid, wherein the modifying comprises performing one or more processing steps selected from contacting with one or more reducing agents, contacting with heat, contacting with thermal energy, contacting with electromagnetic wave, contacting with one or more dehydrating agents, contacting with one or more dehydrogenating agents, contacting with one or more desulfonation reagents, contacting with one or more neutralizing agents, contacting with one or more denitration reagents, contacting with one or more spinning object, stretching, carbonizing, sizing, surface treatment, heating, pressurizing, freezing, contacting with one or more metal oxide, metal, contacting with copper, contacting with silica, or a combination thereof. (iv) purifying the modified nanocolloid by performing one or more purification steps to produce a grapher fiber, and a byproduct comprising an organic product, or a hydrogen product.

It is an object of the present invention to disclose a method comprising providing an asphaltene composition, or a demineralized carbon composition and performing one or more process steps selected from (i) forming a nanocolloid composition by contacting the asphaltene composition, or the demineralized carbon composition with one additives, wherein the nanocolloid composition comprises a network of one or more 2D nanostructures having a lattice structure selected from an orthorhombic system, a monoclinic system, and a triclinic system. (ii) modifying the nanocolloid composition to form a 2D composition by having a lattice structure with a unit cell (CxHy)n or (CxHyR)n wherein x=6 or 7, 3<y<=7, R is a functional group comprising at least one heteroatom, wherein the modifying comprises performing one or more process steps selected from contacting with one or more reducing agents, contacting with heat, contacting with thermal energy, contacting with electromagnetic wave, contacting with one or more dehydrating agents, contacting with one or more dehydrogenating agents, contacting with one or more desulfonation reagents, contacting with one or more neutralizing agents, contacting with one or more denitration reagents, contacting with one or more spinning object, stretching, carbonizing, sizing, surface treatment, heating, pressurizing, freezing, or any combinations thereof. (iii) controlling the nanocolloid composition, or the nanotube composition by performing one or more processing steps of contacting with a selection from metal oxide, metal, copper, silica, steam, thermal energy, pressure, or a combination thereof. (iv) Performing one or more purification steps to produce a graphene fiber, and a byproduct comprising an organic material, or a hydrogen product.

The asphaltene composition in the present invention includes but is not limited to a fractionated asphaltene, a metalized asphaltenes, modified asphaltene, a crude asphaltene, a purified asphaltene, coal, synthetic coal, demineralized coal, bitumen, synthetic bitumen, oil-sand, asphaltene solution, mixed asphaltene, metalized asphaltene, acid purified natural carbon, salt-purified natural carbon, base-purified natural carbon.

It is an object of the present invention to explore a method or a processing step that includes heat treatment under one or more conditions selected from below 100° C., above 100° C., below 500° C., above 500° C., below 1000° C., or above 1000° C., below 5 bar, above 5 bar, below 20 bar, above 20 bar, and any combinations thereof.

The present invention incorporates prior arts on dehalogenation, dehydrogenation, dehydration, dealkylation, denitration, desulfonation, and reduction.

The present invention incorporates WO2014088922A1, U.S. Pat. No. 6,040,490A, and US201220310024A1.

As stated in known arts, vapor deposition process can improve the purity of the product. Also, a more ordered lattice structure can be obtained using chemical deposition method. Present invention incorporates deposition methods of known including chemical vapor deposition, thermal vapor deposition, etc.

### EXAMPLES

The following examples as well as the figures are included to demonstrate preferred embodiments of the invention. It should be appreciated by those of skill in the art that the techniques disclosed in the examples or figures represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Example 1

### Asphaltene Preparation

Numerous methods of processing asphaltene sources (e.g., crude oil) are recognized in the art. The extraction of asphaltene process includes precipitation and purification. One of the extraction processes employed for the production of asphaltene from crude oil is given below.

Materials—Maya crude oil, Heptane (99.8% purity, Toluene (99.9% purity), glass wares, paper filters (40 microns), Nitric acid (EMD NX-0409-2), Sulfuric acid (Fischer A300-212), NaOH (Fischer. Cas No: 1310-73-2), HCl (37.5% Cone.).

Precipitation—Asphaltenes are extracted from crude oil: 100 ml of thoroughly mixed crude oil was dissolved in four liters of heptane and subjected to magnetic stirring for 48 hours at room temperature. The homogeneous mixture was filtered (40 μm filter paper) and rinsed using toluene. The product solution was collected in recrystallization dishes and kept for drying under a hood for 24 hours. About 14 g of dried impure (crude) asphaltene was collected.

Purification—The collected crude asphaltene was dissolved in 400 ml of toluene and placed on a magnetic stirrer for 5 hours, using filter paper no. 40 to separate mixtures. In this case, the purified asphaltene was passed through the filter paper, while the impurities remained on the filter. The collected purified asphaltene solution was poured in to a large beaker and allowed to dry under a hood for 24 hours at room temperature. The result is a black shiny compound (asphaltene).

### Example 1

### Synthesis of Graphene from Asphaltenes

200 mg of asphaltenes is dissolved in 50 ml of a reagent comprising benzene or toluene to form an asphaltene solution. The resulting solution is contacted with an oxidizing agent or potassium per manganate to form a network of carboxylated 2D nanostructure. The 2D nanostructured composition is decarboxylated by contacting with ascorbic acid.

### Example 2

### Synthesis of Graphene from Asphaltenes

200 mg of asphaltenes is dissolved in 50 ml of a reagent comprising benzene or toluene to form an asphaltene solution. The resulting solution is contacted with an oxidizing agent or potassium per manganate to form a network of carboxylated 2D nanostructure. The 2D nanostructured composition is contacted with NaOH and purified. The purified material is contacted with ascorbic acid.

I claim:

1. A method for synthesis of graphene comprising:
Providing a composition comprising network of one or more 2D nanostructures having a d-spacing or interlayer distance less than or equal to 1.367 nm; contacting the composition with one or more reducing agent, wherein the network comprises a lattice structure selected from the group consisting of an orthorhombic system, a monoclinic system, and a triclinic system, wherein the lattice structure is an asymmetric structural unit (ASU)n wherein n is greater than zero and the ASU is represented by a formula of (CxHyF) wherein x=6 or 7, 3:Sy:S6 and F is one or more functional groups selected from the group consisting of one or more nitrogen groups, one or more sulfur groups, one or more hydroxyl groups, one or more OR groups, one or more NHOR groups, one or more halogen groups, one or more halide groups, one or more NR2 groups, one or more SO3H groups, one or more sulfide groups, one or more azo groups, one or more sulfonate groups, one or more CN groups, one or more CH3 groups, one or more N2O4 groups, one or more O3SH3O groups, one or more SO2 groups, one or more NO2 groups, one or more NR3 groups, one or more amide groups, one or more carbonyl groups, one or more oxygen groups, one or more ketone groups, one or more ester groups, one or more carboxyl groups, one or more alkyl groups, one or more acyl groups, one or more carboxylate groups, and combinations thereof.

2. The method according to claim 1, wherein the reducing agent comprises a selection from hydrogen sulphide, sodium borohydride, hydrazine, a de-functionalizing agent, a decarboxylating agent, desulfonating agent, a modifying agent, a controlling agent, a denitrating agent, a modifying agent, an alkaline solution, sodium citrate, amino acids, sugars, ascorbic acid, thermal energy, a metal, zinc, magnesium, primary amine, secondary amine, tertiary amine, copper, sodalime, electromagnetism, polyphenols, tea, microorganisms, or any mixtures thereof.

3. A method for synthesis of graphene comprising:
Contacting an asphaltene derivative with one or more reducing agents selected from hydrogen sulphide, sodium borohydride, hydrazine, a de-functionalizing agent, a decarboxylating agent, desulfonating agent, a denitrating agent, a modifying agent, an alkaline solution, sodium citrate, amino acids, sugars, ascorbic acid, thermal energy, a metal, zinc, magnesium, primary amine, secondary amine, tertiary amine, copper, sodalime, electromagnetism, polyphenols, tea, microorganisms, or a mixture thereof.

4. The method according to claim 4, wherein the asphaltene derivative is a carboxylated asphaltene derivative formed by contacting an asphaltene composition with CO2

5. The method according to claim 4, wherein the asphaltene derivative is a refluxed asphaltene derivative formed by refluxing a mixture of an asphaltene material and one or more additives.

6. The method according to claim 4, wherein the asphaltene derivative is a modified asphaltene derivative formed by contacting a refluxed asphaltene derivative with one or more modifying agents.

7. The method according to claim 4, wherein the asphaltene derivative is a controlled asphaltene derivative by contacting a modified asphaltene derivative with one or more controlling agents.

8. The one or more modifying agents according to claim 6, is selected from a metal, a catalyst, basic solution, a reducing agent, a salt solution, metal oxides, sulfides, hydrides, sodium chloride, sodium hydroxide, ammonium hydroxide, hydrochloric acid, tetrahydrofuran, amino triazole, dimethylformamide, dimethylsulfoxide, phosphines, phosphites, sulfites, sulfides, hydrosulfites, borohydrides, boranes, hydroxylamine, lithium alhydride, sodium nitrite, hydrochloric acid, copper bromide, copper cyanide, potassium iodide, borohydrides, hydrochloric acid, cyanoborohydrides, aluminum hydrides, hydroquininone, hydrogen dimethylhydrazine, N,N-dimethylhydroxylamine, methylamine, dioxane, amino acids, dimethylamine, trimethylamine taurine, methionine, potassium hydroxide, tin, methanol, alkali sulfide, distilled water, or any mixtures thereof.

9. The one or more controlling agents according to claim 6, selected from hydrochloric acid, sodium bicarbonate, methanol, dimethyl sulfoxide, sodium hydroxide, potassium hydroxide, tetrahydrofuran, dimethylformamide, alkali sulfide, dimethylsulfoxide, phosphines, phosphites, sulfites, sulfides, dioxane, hydrosulfites, borohydrides, boranes, distilled water, sodium bicarbonate or any mixtures thereof.

10. The method according to claim 1 or claim 4, further comprising the use of a vapor deposition technique.

11. The method according to claim 1 or claim 4, wherein the graphene is having a lattice structure selected from a hexagonal system, an orthorhombic system, a monoclinic system, and a triclinic system.
